(19) United States
(12) Patent Application Publication
(10) Pub. No.: US 2024/0174052 A1
(43) Pub. Date: May 30, 2024

(54) HEATING DEVICE, PREFERABLY FUEL-OPERATED HEATING DEVICE, FOR A VEHICLE, AND METHOD FOR ASSEMBLING A HEATING DEVICE

(71) Applicant: Webasto SE, Stockdorf (DE)

(72) Inventor: Christian Schweyer, Stockdorf (DE)

(21) Appl. No.: 18/282,634

(22) PCT Filed: Mar. 16, 2022
(86) PCT No.: PCT/EP2022/056850

§ 371 Date: Sep. 18, 2023

(30) Foreign Application Priority Data
Mar. 18, 2021 (DE) 10 2021 106 678.6

(51) Int. Cl. B60H 1/22

(52) U.S. Cl. CPC B60H 1/2212; B60H 2001/2271; B60H 2001/2281

(57) ABSTRACT

The invention relates to a heating device, preferably a fuel-operated heating device for a vehicle, comprising the following: a heat exchanger for heating a fluid in a heating device volume through which flow can pass; a burner device, which has a burner flange, the burner device being disposed within the heat exchanger; and an exhaust gas outlet for discharging exhaust gases from the heating device; a catalytic converter element, which is disposed between the burner flange and the heat exchanger; a spacer which can be attached to the burner flange and which has a height with respect to an exhaust gas flow direction in order to at least one of: position and fix the catalytic converter element in a predefined position near the exhaust gas outlet.

### CROSS-REFERENCE TO RELATED APPLICATIONS

This application is a 35 U.S.C. § 371 National Stage Entry of International Application No. PCT/EP2022/056850 filed Mar. 16, 2022, which claims the priority benefit of German Patent Application Serial Number DE 10 2021 106 678.6 filed Mar. 18, 2021, all of which are incorporated herein by reference in their entirety for all purposes.

### TECHNICAL FIELD

The invention relates to a heating device, preferably a fuel-operated heating device for a vehicle.

### BACKGROUND

In common heating devices—for example, fuel-operated (water) heating devices for a vehicle—components in and/or at corresponding assembly groups (for example, burner assembly groups) are routinely fastened or locked exclusively by material bonding. Usually, welded or soldered joints are provided between burner flange, combustion chamber, burner tube and evaporator receptacle. Due to the material used (often non-organic fiber materials), an evaporator or evaporator package cannot usually be connected by material bonding. The evaporator is therefore inserted into the evaporator receptacle and then materially bonded by means of a welded or soldered retaining ring. A corresponding glow plug is also not usually connected by a material bond, but must be locked in place in a connecting member of the evaporator receptacle by means of a retaining spring (and possibly an additional cooling spring).

If the components are materially bonded, they must be welded or soldered. Welded and/or soldered joints are considered to be comparatively inflexible and time-consuming. On the other hand, a corresponding material selection is limited in this way by the respective welding or soldering properties of the material.

In particular, the integration of catalytically active components (catalytic converter) in an exhaust gas chamber of a heating device often proves to be constructively complex and costly in terms of design. For ideal exhaust gas temperatures at the catalyst, it must be positioned as close as possible to a corresponding exhaust gas outlet. Consequently, the catalytic converter must be arranged at a defined distance downstream of a burner but upstream of the exhaust gas outlet.

EP 3 508 787 A1 shows for a corresponding positioning of a catalyst arrangement 54, for example, a combustion chamber housing support 36 with a radial extension region 56 to support the catalyst arrangement 54 axially. Such (direct) integration of a corresponding spacer or spacer element in a component of the heating device—for example in a combustion chamber housing or in a heat exchanger—can only be carried out via complex forming steps and/or welding or soldering processes. Consequently, additional joining processes, some of them extremely complex, are required to create the corresponding structures. Besides higher production costs, this also results in particular in complicated components of a heating device that are thus more difficult to handle.

### SUMMARY

It is therefore an object of the present invention to provide a heating device that allows flexible and simple attachment of a catalytically active component in a defined position.

In particular, this object is solved by a heating device, preferably a fuel-operated heating device for a vehicle, comprising:
a heat exchanger for heating a fluid in a flushable volume of the heating device;
a burner device having a burner flange, wherein the burner device is arranged within the heat exchanger; and
an exhaust gas outlet for discharging exhaust gases from the heating device;
a catalytic converter element arranged between the burner flange and the heat exchanger; and
a spacer which is configured to be fitted onto the burner flange and which has a height with respect to an exhaust gas flow direction in order to position and/or fix the catalytic converter element in a predetermined position in the proximity of the exhaust gas outlet.

An essential idea of the invention is to optimally position a catalytic converter element of a heating device in an exhaust gas flow in a predetermined position with respect to an exhaust gas outlet without having to integrally form material bonded spacer elements at the burner device or the heat exchanger in complex processes. According to the invention, a corresponding spacer is plugged onto the burner flange during assembly in order to fix the catalytic converter element in a defined position. Once the catalytic converter element has been attached or put in place and the heat exchanger has been assembled, spacer and catalytic converter element can no longer be displaced.

The catalytic converter element can in particular be an oxidation catalytic converter element suitable for converting CO and HC contained in the combustion exhaust gases leaving the combustion chamber to CO2 and H2O in a catalytic reaction. The catalytic converter element may additionally or alternatively also comprise a hydrocarbon accumulator or/and a nitrogen oxide accumulator. It is also advantageously possible that a hydrocarbon storage element or/and a nitrogen oxide storage element are arranged at the burner flange in addition to the catalytic converter element.

By the term that the catalyst is positioned and/or fixed “in the vicinity of the exhaust gas outlet”, it is to be understood in the following that a fixation of the spacer is positioned as close as possible or as near as possible, in particular a few cm, to an exhaust gas outlet of the heating device due to optimum exhaust gas temperatures.

The spacer is arranged in particular downstream of the catalytic converter in relation to the exhaust gas flow direction at the burner flange.

A vehicle for which the heating device may be configured is understood to mean all types of vehicles such as motor vehicles (for example automobiles), trucks, trains, boats or ships, motor homes, caravans or other trailers.

In a particularly preferred embodiment a fixation of the spacer is performed in a force-fit manner, preferably exclusively in a force-fit manner.

As a result, in a corresponding manufacturing process, corresponding steps for integral forming of a corresponding spacer into a component of the heating device are eliminated.

In addition, no welding or soldering of the connection is necessary. The assembly process is therefore significantly simplified and can be carried out particularly cost-effectively. In alternative embodiments, the spacer can be (reversibly) locked to the burner flange using additional fastening means (for example rivets, screws, or the like).

In an embodiment, the heat exchanger has a plurality of radially projecting heat exchanger fins, wherein the heat exchanger fins extend in a first region along a burner tube of the burner device and in a second region at least partially over the burner flange.

By providing heat exchanger fins, an efficient heat transfer from the heat exchanger to the fluid flowing around the heat exchanger is allowed. Surprisingly, it has also been found that quieter operation of the heating device is enabled if the heat transfer fins do not extend over the entire heat exchanger, but only over a (partial) area of the heat exchanger. For example, the heat exchanger fins can thus extend essentially axially over only half of the heat exchanger, preferably axially essentially over about 60% of the length of the heat exchanger.

In an embodiment, the heat exchanger has at least one step, wherein the step is configured and/or arranged to form-fittingly fix the catalytic converter element between the step and the spacer.

Whereby the at least one step is understood to be, for example, an at least partially circumferential or sectional projection of an inner wall of the heat exchanger. Alternatively, the at least one step can also be formed by an (upper) end of the heat exchanger fins. In this way, a material bond between burner device (or heat exchanger) and spacer or catalytic converter element is avoided. In the course of development work, a material bond between burner device (or heat exchanger) and spacer or catalytic converter element has proved to be disadvantageous, particularly with regard to stability, a high punching waste of components or by negatively influencing the catalytic properties. These disadvantages are overcome by a form-fit fixation of the catalyst and a force-fit connection of the spacer. In this way, both the manufacturing process and the assembly process are further simplified and both material (costs) and production costs are saved.

In an embodiment, the spacer is formed as a single-piece sheet metal element, in particular a spring strip steel element.

A single-piece element or component allows optimum stability of the spacer on the one hand. On the other hand, a single-piece element allows a particularly fast or simple assembly/disassembly of the spacer. Moreover, on the other hand, the spacer made of a sheet metal element or a spring strip steel element is also comparatively inexpensive to manufacture. The material of the spacer can also be optimized in a simple manner for exhaust gas resistance and/or elasticity for a necessary clamping force on the burner flange.

In an embodiment, the spacer has a wall thickness in a range from 0.2 mm to 1.5 mm, preferably in a range from 0.3 mm to 0.9 mm, further preferably less than 2 mm.

With such a small wall thickness of the spacer (perpendicular to an exhaust gas flow direction), the flow of the exhaust gas through the spacer is only minimally affected. This enables an efficient operation of the heating device and also reduces noise development during operation of the heating device. In addition, the spacer is comparatively light or weight-saving in this way, which is particularly advantageous in the automotive sector.

In an embodiment, the height of the spacer is between 5 mm and 25 mm, preferably between 10 mm and 20 mm, more preferably between 15 mm and 18 mm.

In this way, the spacer is dimensionally stable on the one hand, which facilitates handling during assembly and makes it possible to provide a robust heating device overall. On the other hand, the height of the spacer allows the predetermined position of the catalytic converter element on/at the burner flange (in relation to the exhaust gas outlet) to be determined/optimized.

In an embodiment, the height of the spacer is configured such that, in the predetermined position, the catalytic converter element (in an assembled state of the heating device) at least partially covers an air supply area arranged inside the burner flange.

Such an arrangement of the catalytic converter element (by means of the spacer) in an upper region of the burner unit makes it possible to extend the heat exchanger fins into this upper region. In this way, efficient heat transfer is made possible.

In an embodiment, the height of the spacer is configured such that an upper end of the catalytic converter element in the predetermined position is substantially at the same height as a lower end of the exhaust gas outlet.

In this way, the catalytic converter element can be positioned as close as possible to the exhaust gas outlet without the catalytic converter element interfering with a flow through the exhaust gas outlet. In this way, an optimal position of the catalytic converter element is provided with regard to exhaust gas temperature (at the catalytic converter element) and flow characteristics of the exhaust gas. This enables efficient and low-emission operation of the heating device.

In an embodiment, the height of the spacer is configured such that the catalytic converter element in the predetermined position is at the greatest possible distance in the exhaust gas flow direction from a burner tube exhaust gas outlet arranged at a lower end of the burner tube.

This ensures that a catalytic effect of the catalytic converter element is not impaired by excessively high temperatures at a burner tube exhaust gas outlet on the underside of the burner tube.

In an embodiment, the spacer is substantially c-shaped, such that the spacer has an opening region and the spacer is designed to be plugged onto and unplugged from the burner flange via the opening region in the radial direction or in the axial direction.

In this way, the spacer can be formed as a simple punched bending part. Compared with complex deep-drawn parts or slotted tubular parts (which could also serve as spacers), this has the advantage that no post-processing is required for a punched bending part. In this way, a production of the spacer and thus of the heating device can be carried out quickly, easily and comparatively inexpensively.

In an embodiment, the spacer has a plurality of bending segments angled towards each other, preferably between 5 and 15 bending segments, such that the spacer has a polygonal cross-section.

In a preferred embodiment, the spacer has, for example, nine bending segments. With nine bending segments, these are, for example, each angled at about 150° to each other, so that the spacer as a whole essentially encloses a 270° angle with an opening of essentially 90°. In this way, the burner flange can be “clamped” well with the spacer element, so that the spacer cannot easily come loose by itself. This makes the arrangement particularly robust. However, the number of bending segments is, of course, not fixed at nine or twelve and may deviate therefrom. According to the invention, only a number of bending segments as well as an opening is required, such that a substantially polygonal cross-section of the spacer results.

In an alternative embodiment, the spacer comprises a plurality of bending segments angled towards each other, preferably between 5 and 15 bending segments, such that the spacer has an elliptical or elliptical-open cross-section.

Such a design of the spacer allows, for example, non-rotationally symmetric geometries of burner flange and/or catalytic converter element to be mounted in a stable and robust manner. Depending on the manufacturing process, it may also be easier to produce a spacer with a non-polygonal (that is, for example, elliptical or elliptical-open) cross-section.

In an embodiment, the spacer has a plurality of embossing regions each connecting two adjacent bending segments, wherein the embossing regions are preferably arranged uniformly along a circumferential centerline of the spacer.

By embossing (stamping) the embossing areas, a resistance moment of the spacer is increased. In this way, the dimensional stability of the spacer is further improved. This prevents the material from springing up due to elastic recovery when the bending segments are bent or when the spacer is bent. In this way, a precise dimensioning of the spacer is maintained. Overall, this enables a precise and accurately fitting assembly of the spacer.

In an embodiment, the spacer, on a side facing the burner flange, has a plurality of, in particular at least three, contact projections which are configured and/or arranged to form a supporting surface between the spacer and the burner flange.

For example, it is also conceivable that a contact projection is formed per bending segment or on every second bending segment. This simplifies the functionally relevant areas of the spacer—for example with regard to a measurement of the spacer. In addition, the contact projections minimize the contact surface between the spacer and the burner flange in order to avoid or significantly minimize any contact corrosion that may occur.

In an embodiment, the spacer has an inner circle diameter that is smaller than a diameter of the burner flange, such that the fitted spacer provides a restoring force to fix the spacer onto the burner flange.

In this way, when the spacer is fitted onto the burner flange, the elasticity of the spacer material provides the necessary restoring force for a force-fit connection or clamping of the spacer on the burner flange. For example, a spring steel (1.4310) can be used to provide the best possible workability and/or an optimum restoring force.

In an embodiment, the catalytic converter element is substantially annular or in the form of an open ring and/or comprises a knitted metal mesh, in particular a coated knitted metal mesh.

The annular (or approximately annular) design or the design in form of an open ring enables the catalytic converter element to be plugged onto the burner flange of the heating device. By completely (or partially) enclosing the burner flange with the catalytic converter element after it has been plugged on, the catalytic converter element is additionally fixed to prevent it from slipping. Overall, this improves stability.

In an embodiment, the heating device is formed as a water heating device for heating water in a flushable volume of the heat exchanger and/or is formed as an air heating device for heating air in a flushable volume of the heat exchanger.

Thus, a particularly energy-efficient, comparatively low-emission and low-noise heating device for a vehicle is provided.

The object of the invention is also solved by a method of assembling a heating device, preferably a fuel-operated heating device for a vehicle, wherein the method comprising the following steps:
Providing a burner device;
Fitting a spacer onto a burner flange of the burner device;
Fitting a catalytic converter element onto the burner flange;
Inserting the burner device into a heat exchanger, in such a way that the catalytic converter element is positioned and/or fixed between a step of the heat exchanger and the spacer in a predetermined position in the proximity of an exhaust gas outlet of the heating device, preferably in a form-fitting manner.

It should be noted here that the features and advantages described in the context of the heating device according to the invention also apply to the method of assembling the heating device according to the invention. Features of the device are transferable to the method according to the invention. Likewise, features of the method according to the invention are transferable to the device according to the invention by configuring the corresponding device in such a way that it is suitable for carrying out the corresponding method features.

Further, the object of the invention is also solved by using of a heating device as described above as a parking heater and/or auxiliary heater in a vehicle.

This results in the same advantages as already described in connection with the heating device. In particular, the heating device or the burner of the heating device can be supplied with fuel from a fuel tank of the vehicle, preferably motor vehicle.

### BRIEF DESCRIPTION OF THE DRAWINGS

In the following, the invention will also be described with respect to further details, features and advantages, which will be explained in more detail with reference to the figures. The features and combinations of features described, as shown below in the figures of the drawing and described with reference to the drawing, are applicable not only in the combination indicated in each case, but also in other combinations or on their own, without thereby leaving the scope of the invention.

It shows:

FIG. 1 a partial sectional view of an embodiment example of a heating device according to the invention with a heat exchanger;

FIG. 2 a partial sectional view of an embodiment example of a heating device according to the invention with burner flange and attached catalytic converter element and spacer;

FIG. 3 a perspective view of an embodiment example of a spacer according to the invention which can be plugged onto a burner flange;

FIG. 4 a cross-sectional view of an embodiment example of a spacer according to the invention with polygonal cross-section, which can be plugged onto a burner flange;

FIG. 5 a perspective view of an embodiment example of a spacer according to the invention and a burner device, schematically showing how the spacer is plugged onto the burner flange with catalytic converter element;

FIG. 6 a cross-sectional view of an embodiment example of a heating device according to the invention.

### DETAILED DESCRIPTION

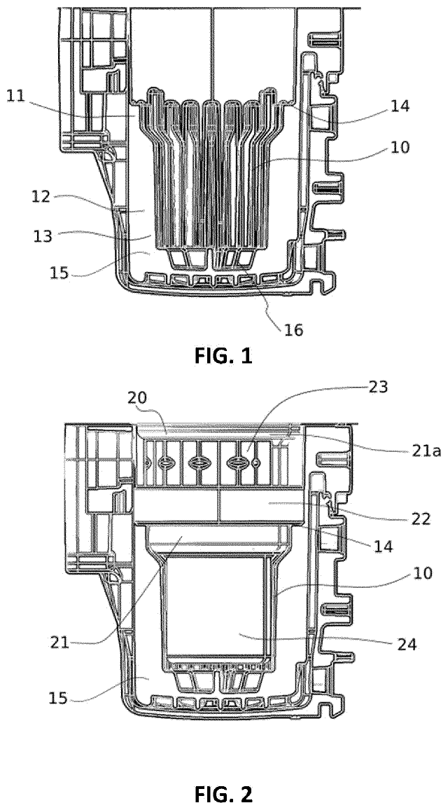

In FIG. 1, an embodiment example of a heating device according to the invention is shown. The illustration in FIG. 1 is a partial sectional view. Inside the heating device, a heat exchanger 10 comprising a volume 15 is arranged. The volume 15 of the heat exchanger 10 may thereby have a fluid flowing through it, such that the heat exchanger 15 is flushed to generate a heat transfer to the fluid.

The heat exchanger 10 has a plurality of radially projecting heat exchanger fins 13.

Whereby the heat transfer fins 13 extend in a first region 12 along a burner tube 24 of the burner device 20 and extend in a second region 11 at least partially over the burner flange 21.

In the embodiment example according to FIG. 1, the heat exchanger fins 13 extend along approximately 60% of the length of the heat exchanger. Alternatively, the heat exchanger fins may extend over 50-80% of the length of the heat exchanger.

The heat exchanger 10 may include a plurality of fluid conducting and/or turbulence generating elements 16 at a lower end. The fluid conduction and/or turbulence generating elements 16 thereby enable an optimized flow around the heat exchanger 10, with respect to a heat transfer.

Inside the heat exchanger a (fuel-operated) burner device 20 is arranged (not shown, cf. for this FIG. 2), which is adapted to heat (by means of the heat exchanger 10) the fluid in the volume 15. The second region 11 of the heat exchanger 10 has a larger diameter than the first region 12 of the heat exchanger 10. The heat exchanger 10 is configured such that a catalytic converter element 22 can be arranged within the second region 11.

In the embodiment example according to FIG. 1, a beveled region of the heat exchanger fins 13 is provided over which the heat exchanger fins 13 extend. In this case, the beveled region is formed such that a diameter of the heat exchanger tapers from the second region 11 to the first region 12. In this way, the flow around the heat exchanger 10 and thus a heat transfer can be optimized.

Furthermore, the heat exchanger 10 comprises at least one step 14.

Thereby, the step 14 can be configured and/or arranged to form-fitly fix the catalytic converter ring element 22 between the step 14 and the spacer 23.

FIG. 2 shows a partial sectional view of an embodiment example of the heating device according to the invention. Here, the burner device 20 within the heat exchanger 10 is highlighted.

The burner device 20 has a burner flange 21 at an upper end, the burner flange 21 being arranged within the second region 11 of the heat exchanger 10. Further, the burner device 20 includes a burner tube 24 at a lower end, the burner tube 24 being arranged within the first region 12 of the heat exchanger 10.

Within the second region 11 of the heat exchanger 10 is an exhaust gas outlet (not shown) for discharging exhaust gases generated by fuel combustion in the burner device.

A catalytic converter element 22 is fitted onto the burner flange 21 of the burner device 20. In this embodiment example, the catalytic converter element 21 is annular for this purpose.

In one embodiment example, the catalytic converter element 22 is (at least partially) formed from a knitted metal fabric coated with a catalytically active component. Alternatively, the catalytic converter may be formed by a monolithic catalytic converter assembly.

In order to optimally position the catalytic converter element 22 with respect to the exhaust gas outlet, a spacer 23 is fitted onto the burner flange 21. In this case, the spacer 23 is configured as a one-piece sheet metal element, in particular a spring strip steel element. At an upper end, the spacer abuts a collar 21a of the burner flange 21.

A lower end of the catalytic converter element 22 abuts against the step 14 of the heat exchanger. The step 14 is configured and/or arranged to form-fit the catalytic converter element 22 between the step 14 and the spacer 23 (after assembly).

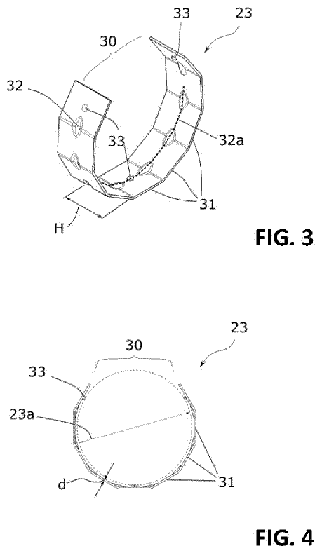

FIG. 3 shows a perspective view of an embodiment example of a spacer 23.

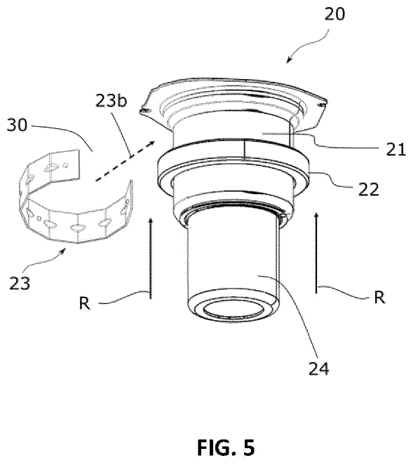

According to the embodiment example shown, the spacer 23 is essentially c-shaped, such that the spacer 23 has an opening area 30 and the spacer 23 can be fitted onto or removed (detachable) from the burner flange 21 via this opening area 30 in the radial direction 23b (see also FIG. 5).

In an alternative embodiment example, the spacer can also be configured to be fitted axially onto the burner flange 21. For this purpose, the opening area 30 could also be designed to be relatively small or closed, for example.

The spacer 23 according to the embodiment example in FIG. 3 has nine bending segments 31 angled towards each other in such a way that the spacer 23 has a polygonal cross-section.

In the embodiment example shown in FIG. 3, the spacer has nine bending segments 31. The bending segments 31 each have (at least substantially) the same length. Alternatively, the number of bending segments 31 can vary—for example, twelve bending segments 31 can be realized. The respective lengths of the individual bending segments 31 may also differ in alternative embodiment examples.

The spacer 23 can be made of spring steel (1.4310), for example, in order to provide the best possible workability and/or an optimal restoring force after fitting onto the burner flange 21.

In addition, the spacer 23 has a plurality of embossing areas 32, each connecting two adjacent bending segments 31. Whereby the embossing areas 31 are preferably arranged uniformly along a circumferential centerline 32a of the spacer 23.

By means of the embossing areas 32, springing of the material due to elastic recovery is avoided during bending (manufacturing) of the spacer 23. Thus, accurate dimensioning of the spacer 23 is maintained and the dimensional stability of the spacer 23 is increased.

The embossing areas 32 may be embossed into a (still planar) elongated sheet metal element in a method for manufacturing the spacer 23, before it is bent into a plurality of, preferably nine, bending segments 31 by a plurality of bending steps, such that the spacer 23 has a substantially c-shaped and/or substantially polygonal cross-section after the bending steps have been performed. The method may optionally also comprise a step of embossing contact projections 33.

As shown in the embodiment example according to FIG. 3, the spacer has three contact projections 33. The contact projections 33 are arranged on an inner side of the spacer 23. Whereby by inner side is meant the side that comes into contact with the surface of the burner flange 21 after fitting onto the burner flange (see, for example, FIG. 2).

The contact projections 33 minimize an abutting contact surface between the spacer 23 and the burner flange 21 in order to avoid or substantially minimize any contact corrosion that may occur.

The (predetermined) position of the catalytic converter element 22 at the burner flange is determined by the height H of the spacer 23.

For example, it is conceivable to use two different spacers 23, each with a corresponding height H, for two catalytic converter elements 22 which differ with respect to their respective heights. In this way, the heating device is particularly flexible, since different catalytic converter elements 22 and/or different spacers 23 can be used.

The corresponding height H of each spacer 23 is thereby designed for the optimum position of the catalytic converter element 22 in relation to the position of the exhaust gas outlet of the heating device.

FIG. 4 shows a cross-sectional view of an embodiment example of the spacer 23.

In cross-section, the spacer 23 has a substantially c-shaped and/or a substantially polygonal cross-sectional shape. This cross-sectional shape is obtained on the basis of bending segments 31 angled with respect to each other.

As in the embodiment example according to FIG. 3, the embodiment example according to FIG. 4 shows a spacer with nine bending segments 31. For example, with nine bending segments 31, each of these are angled at approximately 150° to each other so that the spacer 23 as a whole includes an angle of substantially 270° with an opening area 30 of substantially 90°.

The spacer 23 has a (thought completed) inner circle diameter 23a that is smaller, in particular slightly smaller, than a diameter of the burner flange 21. In this way, when the spacer is fitted onto the burner flange 21, the elasticity of the material of the spacer 23 provides the necessary restoring force for a force-fit connection or clamping of the spacer 23 on the burner flange 21. For example, a spring steel 1.4310 can be used to provide the best possible workability and/or an optimal restoring force.

The spacer 23 or the sheet metal element has a wall thickness d in a range from 0.3 mm to 0.9 mm, further preferably less than 1 mm. A wall thickness d (perpendicular to an exhaust gas flow direction R, see FIG. 5) of the spacer 23 of 0.5 mm is particularly preferred.

Due to the low wall thickness d of the spacer 23, the exhaust gas flow is only minimally impaired.

FIG. 5 shows a schematic diagram illustrating the fitting of the spacer 23 onto the burner flange 21.

The burner device 20 has a burner flange 20 and a burner tube 24. The exhaust gases exiting the burner tube flow (within the heat exchanger not shown in FIG. 5) in the exhaust gas flow direction R along the burner device 20 upward toward the catalytic converter element 22.

The catalytic converter element 22 is fitted onto the burner flange 21. In order to position and/or fix the catalytic converter element 22 in an optimal position (with respect to the exhaust gas flow direction R), the spacer 23 is fitted onto the burner flange in a radial direction 23b (“radial” refers to the spacer).

Alternatively, it is conceivable to first fit the spacer 23 onto the burner flange 21 in the axial direction R and then to fit the catalytic converter element 22 onto the burner flange 21.

After assembly of the heat exchanger (not shown in FIG. 5), spacer and catalytic converter element can no longer be displaced.

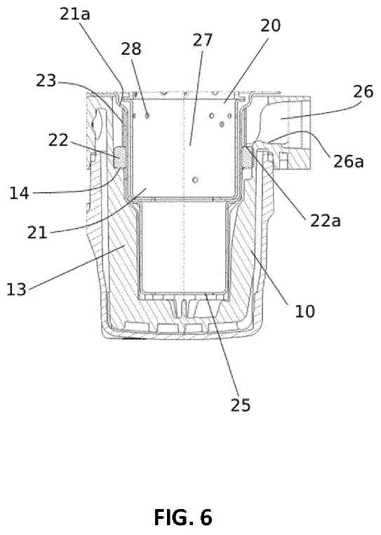

FIG. 6 shows a cross-sectional view of an embodiment example of a heating device according to the invention.

The burner device 20 is inserted into a heat exchanger 10.

A spacer 23 is fitted onto the burner flange 21. The spacer 23 rests at its upper end against a collar 21a of the burner device 20.

In the embodiment example according to FIG. 6, the height H of the spacer 23 is configured such that the catalytic converter element 22 at least partially covers an air supply region 27 arranged within the burner flange 21.

The air supply region 27 has a plurality of air supply openings 28 leading to a combustion chamber (not shown) of the burner device 20 within the burner flange 21.

In the embodiment example according to FIG. 6, the height H of the spacer is configured such that an upper end 22a of the catalytic converter element 22 in the predetermined position is substantially at the same height as a lower 26a end of the exhaust gas outlet 26 of the heating device.

In this way, the catalytic converter element 22 can be positioned as close as possible to the exhaust gas outlet 26 without the catalytic converter element 22 interfering with (blocking) a flow of exhaust gas through the exhaust gas outlet.

At its upper end, the catalytic converter element 22 abuts the spacer 23.

At a lower end of the catalytic converter element 22, the catalytic converter element 22 rests on a step 14 of the heat exchanger 10.

In the embodiment example according to FIG. 6, the step 14 is formed by an upper end of the heat exchanger fins 23.

The upper ends of the heat exchanger fins 23 extend partially over the air supply region 27 within the burner flange 21.

At this point, it should be noted that all parts described above are claimed to be essential to the invention when considered alone and in any combination, particularly the details shown in the drawings.

1: A heating device, comprising:
a heat exchanger for heating a fluid in a flushable volume of the heating device;
a burner device having a burner flange, wherein the burner device is arranged within the heat exchanger; and
an exhaust gas outlet for discharging exhaust gases from the heating device;
a catalytic converter element arranged between the burner flange and the heat exchanger; and
a spacer which is configured to be fitted onto the burner flange and which has a height with respect to an exhaust gas flow direction in order to position the catalytic converter element in a predetermined position in the proximity of the exhaust gas outlet.

2: The heating device according to claim 1, wherein
positioning of the catalytic converter element comprises fixing the spacer in the predetermined position in a force-fit manner.

3: The heating device according to claim 1, wherein
the heat exchanger has a plurality of radially projecting heat exchanger fins, wherein the heat exchanger fins extend in a first region along a burner tube of the burner device and in a second region at least partially over the burner flange.

4: The heating device according to claim 1, wherein
the heat exchanger has at least one step, wherein the step is configured to form-fittingly fix the catalytic converter element between the step and the spacer.

5: The heating device according to claim 1, wherein
the spacer is formed as a single-piece sheet metal spring element.

6: The heating device according to claim 1, wherein
the spacer has a wall thickness in a range from 0.2 mm to 2 mm.

7: The heating device according to claim 1, wherein
the height of the spacer is between 5 mm and 25 mm.

8: The heating device according to claim 1, wherein
the height of the spacer is configured such that, in the predetermined position, the catalytic converter element at least partially covers an air supply region arranged inside the burner flange.

9: The heating device according to claim 1, wherein
the height of the spacer is configured such that an upper end of the catalytic converter element in the predetermined position is substantially at the same height as a lower end of the exhaust gas outlet.

10: The heating device according to claim 9, wherein
the height of the spacer is configured such that the catalytic converter element in the predetermined position is at the greatest possible distance in the exhaust gas flow direction from a burner tube exhaust gas outlet arranged at a lower end of the burner tube.

11: The heating device according to claim 1, wherein
the spacer is substantially c-shaped, such that the spacer has an opening region and the spacer is configured to be plugged onto and unplugged from the burner flange via the opening region in at least one of: the radial direction and the axial direction.

12: The heating device according to claim 1, wherein
the spacer has a plurality of bending segments angled towards each other such that the spacer has a polygonal cross-section.

13: The heating device according to claim 1, wherein
the spacer comprises a plurality of bending segments angled towards each other such that the spacer has at least one of: an elliptical and elliptical-open cross-section.

14: The heating device according to claim 12, wherein
the spacer has a plurality of embossing regions each connecting two adjacent bending segments.

15: The heating device according to claim 1, wherein
the spacer, on a side facing the burner flange includes at least one contact projections configured to form a supporting surface between the spacer and the burner flange.

16: The heating device according to claim 1, wherein
the spacer has an inner circle diameter that is smaller than a diameter of the burner flange, such that the fitted spacer provides a restoring force to fix the spacer onto the burner flange in the predetermined position.

17: The heating device according to claim 1, wherein
the catalytic converter element is comprises a substantially annular form.

18: The heating device according to claim 1, wherein
the heating device comprises at least one of: a water heating device for heating water in a flushable volume of the heat exchanger and an air heating device for heating air in a flushable volume of the heat exchanger.

19: A method of assembling a heating device, the method comprising the following steps:
providing a burner device;
fitting a spacer onto a burner flange of the burner device;
fitting a catalytic converter element onto the burner flange;
inserting the burner device into a heat exchanger, in such a way that the catalytic converter element is positioned between a step of the heat exchanger and the spacer in a predetermined position in the proximity of an exhaust gas outlet of the heating device.

20: A method of using a heating device as at least one of: a parking heater and an auxiliary heater in a vehicle, wherein the heating device comprises:
a heat exchanger for heating a fluid in a flushable volume of the heating device;
a burner device having a burner flange, wherein the burner device is arranged within the heat exchanger; and
an exhaust gas outlet for discharging exhaust gases from the heating device;
a catalytic converter element arranged between the burner flange and the heat exchanger; and
a spacer which is configured to be fitted onto the burner flange and which has a height with respect to an exhaust gas flow direction in order to position the catalytic converter element in a predetermined position in the proximity of the exhaust gas outlet.
